(19) United States
(12) Patent Application Publication
(10) Pub. No.: US 2022/0052867 A1
(43) Pub. Date: Feb. 17, 2022

(54) User Proximity Sensing For Automatic Cross-Device Content Transfer

(71) Applicant: Google LLC, Mountain View, CA (US)

(72) Inventors: Aiko Nakano, Mountain View, CA (US); Diane C. Wang, San Francisco, CA (US); Elena Jessop Nattinger, San Carlos, CA (US)

(73) Assignee: Google LLC, Mountain View, CA (US)

(21) Appl. No.: 17/284,850

(22) PCT Filed: May 8, 2020
(86) PCT No.: PCT/US2020/032029

§ 371 Date: Apr. 13, 2021

(51) Int. Cl. H04L 12/28; H04W 4/02

(52) U.S. Cl. CPC H04L 12/2829; H04L 12/282; H04L 2012/2841; H04L 2012/2849; H04W 4/025

(57) ABSTRACT

Methods, architectures, and algorithms to improve content transfer performance, smoothness and efficiency among multiple electronic computing devices are provided. In one example, an electronic computing device includes a plurality of sensors or devices, a communication interface, a memory device configured to store computer-executable instructions, and a processor, wherein the processor is configured to determine a proximity of a user relative to the electronic computing device in an environment detected by the plurality of the sensors or devices and determine a transfer of a content based on a proximity metric stored from the memory device.

### BACKGROUND

Homes or offices equipped with multiple electronic computing devices have become increasingly popular. People may interact with a number of different electronic devices on a daily basis at homes or in the offices. For example, a person may frequently interact with electronic devices, computers, smart televisions, tablets, wearable devices, lighting systems, alarm systems, entertainment systems, and a variety of other electronic devices at home or in the office. Many new homes or office offices are built fully wired or utilize various wireless systems to facilitate use and communication of the different electronic devices therein.

As the electronic devices in homes and offices continue to evolve, efficient communications among the multiple electronic devices have become increasingly important. As the user travels from room to room and/or from device to device, the content transfer among the multiple electronic devices often requires the user to perform some type of actions, such as a series of clicks or a voice and/or sound command, to the various electronic devices in the environment to make content transfer. However, such actions are often disruptive and cumbersome to the user.

### BRIEF SUMMARY

Methods, architectures and algorithms to improve content transfer performance, smoothness and efficiency among multiple electronic computing devices are provided. In one example, an electronic computing device includes a plurality of sensors or devices, a communication interface, a memory device configured to store computer-executable instructions, and a processor, wherein the processor is configured to determine a proximity of a user relative to the electronic computing device in an environment detected by the plurality of the sensors or devices and determine a transfer of a content based on a proximity metric stored from the memory device.

In one example, the communication interface includes at least one receiver and transmitter to communicate with the second electronic computing device. In one example, the one or more sensors includes at least one of an audio input device, audio output device, light sensor, motion detector, thermal sensor, or image sensor. In one example, the proximity of the user is detected by the strength of an electronic signal from a portable device, a holdable device or a wearable device carried by the user. The electronic signal is at least one of WiFi signal, Bluetooth signal, and a cloud service signal.

In one example, the memory device provides an algorithm configured to execute the proximity metric to determine the transfer of the content. The algorithm can be but not necessarily automatically updated by machine learning. In one example, the algorithm provides a gradual fading of the content when the content is determined to be transferred. The algorithm provides a priority list to determine the transfer of the content when multiple users are present in the environment. In one example, the proximity metric includes floor plan or room understanding.

Another aspect of the disclosure provides an electronic computing system includes a first electronic computing device located in a first location in an environment, and a second electronic computing device located in a second location of the environment. The first electronic computing device includes one or more sensors, a communication interface, a memory device configured to store computer-executable instructions, and a processor. The processor is configured to determine a proximity of a user relative to the first electronic computing device in the environment detected by the one or more sensor, and determine a transfer of content to the second electronic computing device based on a proximity metric stored from the memory device.

A further aspect of the disclosure provides a method for content transfer includes detecting, with one or more sensors, a presence of a user by a first electronic computing device, determining, with one or more processors, a proximity of the user relative to the first electronic computing device in an environment, and determining, with one or more processors, whether to transfer content from the first electronic computing device to or from a second electronic computing device based on a proximity metric in the first electronic computing device or one or more portable devices.

In one example, the proximity metric includes floor plan or room understanding.

### BRIEF DESCRIPTION OF THE DRAWINGS

FIG. 1 depicts an example environment including multiple electronic computing devices that interact with a user located in the environment according to aspects of the disclosure.

FIG. 2 depicts another example environment including multiple electronic computing devices that interact with a user located in the environment according to aspects of the disclosure.

FIG. 3 depicts yet another example environment including multiple electronic computing devices that interact with a user located in the environment according to aspects of the disclosure.

FIG. 4 depicts still another example environment including multiple electronic computing devices with a cloud service assistance that provides interaction with a user located in the environment according to aspects of the disclosure.

FIG. 5 depicts yet another example environment including multiple electronic computing devices with a network service assistance that provides interaction with a user located in the environment according to aspects of the disclosure.

FIG. 6 depicts a configuration of an electronic computing device utilized in the examples depicted in FIGS. 1-5.

FIG. 7 depicts functional diagrams with regard to an interaction of a user to multiple electronic computing devices with multiple functions according to aspects of the disclosure.

FIG. 8 depicts a flow diagram of a process for providing a content transfer among electronic computing devices according to aspects of the disclosure.

FIG. 9 depicts a flow diagram of a process for providing a content transfer among electronic computing devices by an interaction from multiple users according to aspects of the disclosure.

### DETAILED DESCRIPTION

This disclosure includes methods, architects and algorithms related to an electronic computing device and/or an electronic computing system comprising the electronic computing device for content transfer automation, smoothness and efficiency among multiple electronic computing devices. The multiple electronic computing devices may be located at different places, such as inside and/or outside of a building structure (e.g., a home or an office) or remotely distant away from each other. In one example, the content transfer may be achieved by detecting a movement of a user by one electronic computing device and responding to the user movement by requesting a transfer or relay of the content to another electronic computing device. For example, when the user is in motion from a first room having a first electronic computing device toward a second room having a second electronic computing device, such detection of the user movement from the first electronic computing device may send a request to the second electronic computing device. The second electronic computing device then receives the content (or content status) from the first electronic computing device and seamlessly relays and performs the content in the second electronic computing device. Thus, the active content may be automatically transferred among the electronic computing devices by detection of a proximity and/or a movement of the user with or without knowing by the user. In some examples, states of content may be transferred from the first electronic computing device to the second electronic computing device so that the first or the second electronic computing devices may determine if a transfer is needed. In the example wherein the content is on cloud services, the content is sent from the cloud services with appropriate states. Thus, a user triggered transfer, such as a voice command, audible request, or other types of user activation, may be eliminated so that a smooth and seamless transfer of the content among different electronic computing devices may be obtained with minimum activation/action required from the user.

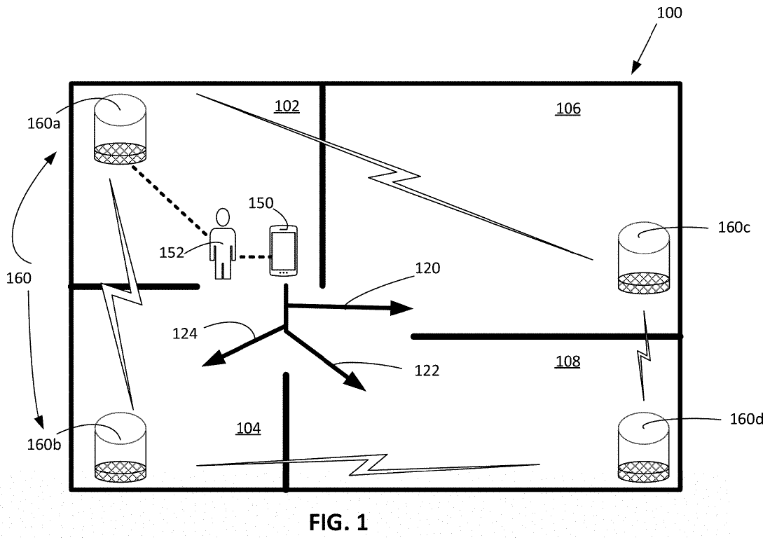

FIG. 1 illustrates an example environment including a building 100, such as a home, a public place, a store or an office, with an electronic computing system including more than one electronic computing device 160 (shown as 160a, 160b, 160c, 160d) located at different spaces, such as a first room 102, a second room 104, a third room 106 and a fourth room 108, of the building 100. Although four electronic computing devices 160a, 160b, 160c, 160d are shown in FIG. 1, it is noted that the numbers of the electronic computing devices utilized in the building 100 may be as many as needed. Suitable examples of the electronic computing device 160 include home assistance devices, task assistance devices, smart devices, intelligent devices, smart detectors, smart speakers, streaming media playing devices, various types of sensors, various types of mobile and stationary computing devices, smart cellular phones, smart wearable devices and/or any suitable wired or wireless electronic computing devices. In one example, the electronic computing device 160 depicted herein is a home assistance device that can assist users in performing various tasks and/or content, such as performing music or video media, voice command, or other tasks.

In one example, the multiple electronic computing devices 160a, 160b, 160c, 160d utilized in the building 100 may be in electronic communication with each other. Thus, when the multiple electronic computing devices 160a, 160b, 160c, 160d are in operation, electronic communications may be provided among the multiple electronic computing devices 160a, 160b, 160c, 160d so that each of the electronic computing devices 160a, 160b, 160c, 160d may identify and recognize the locations of other electronic computing devices 160a, 160b, 160c, 160d and learn if a content, profiles, information or task is performed in any of the electronic computing devices 160a, 160b, 160c, 160d. The electrical communication may be achieved by local or remote networks, such as a wired or wireless network (e.g., Wifi, Bluetooth, ultrasonic, cloud services, etc.). Transfer of the content may be through direct communication among the multiple electronic computing devices 160a, 160b, 160c, 160d.

In some examples, the electronic computing devices 160a, 160b, 160c, 160d may operate independently from each other, utilizing a central networking system or a cloud service for electrical communications. In some examples, the electronic computing devices 160a, 160b, 160c, 160d may operate collectively to have direct or indirect (i.e. mesh networking) electronic communication among each other. Alternatively, the multiple electronic computing devices 160a, 160b, 160c, 160d may communicate to each other in any suitable manners as needed. Each electronic computing device 160a, 160b, 160c, 160d is able to detect the presence of one or more users so as to determine if a content transfer may be made based on the proximity of the user relative to the respective electronic computing devices. The same proximity sensing mechanism may or may not be used by electronic computing device 160a, 160b, 160c, 160d.

In one example, the presence or movement of a user may be detected by monitoring a signal of a device associated with or worn/carried by the user. For example, a wireless signal or an electronic signal of a mobile phone, or wirelessly enabled wearable devices, such as smart watch, smart earbuds, or smart glasses, a tablet device, or other portable, holdable or wearable wireless device, may be utilized to detect the movement of the user. In one example, the user may carry or wear a holdable or wearable device as the user moves from room to room. The electronic computing devices 160a, 160b, 160c, 160d is configured to detect the signals transmitted from such portable, holdable or wearable device by wireless network (e.g., Wifi, Bluetooth, ultrasonic, cloud services, etc.) so as to determine if a transfer of an active content is necessary as the user moves. The electronic computing devices 160a, 160b, 160c, 160d may detect any suitable signals of a device associated with or worn/carried by the user. Alternatively, the presence or movement of a user may be detected by other types of the signals, such as an electrical signal (e.g., infrared radiation) radiated by human body heat, a sound signal related to the user, an interference signal that corresponds to a presence of a human, or an audible response or speech recognition provided from the user and the like. Another example is the use of time-of-flight based approaches for Wifi signal, ultrasonic signal, infrared light, radio frequencies, or laser light. Alternatively, a person detection algorithm based on computer vision or infrared motion detection can be used to determine proximity to devices, in which case a portable device is not required to be worn or carried by the user to determine the proximity of the user to the electronic computing device.

In the example depicted in FIG. 1, the first electronic computing device 160a may detect a wireless signal emitted by a holdable device 150, such as a smart phone, carried by the user 152. Thus, a local network between the first electronic computing device 160a and the holdable device 150 carried by the user 152 is formed and the first electronic computing device 160a and the holdable device 150 are electrically synchronized. Accordingly, the first electronic computing device 160a is able to transfer the contents, such as incoming or outgoing phone calls, music media, video content, from the holdable device 150 to the first electronic computing device 160a. Thus, the user 152 may transfer the content, such as conducting a phone conversation, listening to music, watching a video, etc., from the holdable device 150 to the first electronic computing device 160a in the first room 104. In some examples, the first electronic computing device 160a may have built in speaker or voice recognition capabilities, such that a phone call or a command for performing a task may be received directly by the first electronic computing device 160a and/or other electronic computing device 160b, 160c, 160d and the user may answer the phone call or inputting command to any of the electronic computing device 160a, 160b, 160c, 160d without the holdable device 150 being involved.

As the user 152 moves from the first room 102 to the second room 104, shown as the path 124, the first electronic computing device 160a may detect the user 152 by the gradually weakening wireless signal from the holdable device 150, thus initiating a transfer of the content from the first electronic computing device 160a to output in the second electronic computing device 160b located in the second room 104 where the user 152 is heading to. In another example, the holdable device 150 may detect the signal strengths from electronic computing device 160a, 160b, 160c, 160d. In the situation wherein a ToF-based (time of flight-based) technique is utilized, the signal may increase, instead of weakening wireless signal. In this example, a proximity sensing algorithm may be utilized to determine which electronic computing device 160a, 160b, 160c, 160d has the strongest signal (or lowest value for ToF). Once determined, the content may be transferred when the proximity sensing algorithm is confident that the user is moving towards a particular device based a combination of temporal smoothing and thresholding.

Alternatively, the first electronic computing device 160a may initiate a transfer of the content when the first electronic computing device 160a no longer detects the presence of the user 152. In this example, the first electronic computing device 160a may send an inquiry signal to the second electronic computing device 160b, or to the third and fourth electronic computing devices 160c, 160d, to determine if these electronic computing devices 160b, 160c, 160d are able to detect the signal related to the user 152. When the second electronic computing device 160b, for example, responds in the affirmative and is determined to be the closest to the user, the first electronic computing device 160a may make the transfer of the content and/or the profile information to the second electronic device 160b.

In one example, when the user 152 is listening to music from the holdable device 150, initially, the first electronic computing device 160a captures an electrical signal from the holdable device 150 indicating the outputting of an audio content in the holdable device 150. The first electronic computing device 160a then outputs the audio content in the first electronic computing device 160a. As the user 152 moves to from the first room 102 to the second room 104 with the holdable device 150, the first electronic computing device 160a may analyze the detected weakening electrical signal from the holdable device 150 and determine a distance from the first electronic computing device 160a to the user 152 and possibly the direction of movement of the user 152. The first electronic computing device 160a may determine if the user 152 is moving out of the threshold value based on the wireless signal strength (e.g., RSSI strength), Bluetooth signal strength, Wifi signal strength, other signal indicators including time of flight (ToF) based signal, and/or a combination thereof for detecting the position and movement of the user 152. Once the first electronic computing device 160a confirms that the user 152 is moving from the first room 102 to the second room 104, the first electronic computing device 160a may transfer the active audio content to the second electronic computing device 160b. Thus, as the user 152 enters the second room 104, the user 152 may continue to listen to the music output at the second electronic computing device 160b. By doing so, the user 152 experiences a seamless content transfer without undesired sound/music interruption.

In the situation when the user 152 moves to the second room 104 without carrying the holdable device 150 (e.g., the holdable device 150 remained in the first room 102), the first electronic computing device 160a may be able to detect presence, movement or location of the user 152 by other sensors integrated in the first electronic computing device 160a, such as cameras, image or video capturing sensors, thermal or temperature sensors, ultrasonic sensors, light sensors, audio sensors, or other suitable sensors or devices, to determine the location, distance and proximity of the user 152 relative to the first and the second electronic computing device 160a, 160b (or other electronic computing devices 160c, 160d) so as to determine if a transfer of the content is necessary. Thus, each electronic computing device 160 is configured to provide the functions of capturing audio, visual, thermal, or other suitable information from the surrounding environment to help identify presence, movement and location of the user 152 in the environment based on the captured information.

Similarly, when the user 152 moves from the first room 102 to the third room 106 or fourth room 108 instead, as indicated by the paths 120, 122, the first electronic computing device 160a may be in communication with the third or fourth electronic computing device 160a, 160d, similar to the communication to the second electronic computing device 160b described above, so as to determine and coordinate if a transfer of the content is necessary based on the proximity of the user 152 relative to the third or fourth electronic computing device 160c, 160d.

In some examples, a content transition technique may be utilized to provide a smooth transition of the content among electronic computing devices. In one example, the content transition technique is a smoothing technique that includes a fade in and fade out smoothing technique, temporal smoothing technique or other suitable smoothing techniques to assist device selection or transition between appropriate devices. In one example, the fade in and fade out content transition technique may be one of the algorithm configured in a content transition technique. The content transition technique may provide algorithms with multiple smooth transition functions. For example, when a transfer of a content is initiated from the first electronic computing device 160a to the second electronic computing device 160b, the content playing in the first electronic computing device 160a may be smoothly transitioned to the second electronic computing device 160b by gradually fading the content output in the first electronic computing device 160a and gradually implementing the content output in the second electronic computing device 160b. Such smooth transition may protect against noisy proximity signals that might cause content to immediately bounce from one device to another, resulting in a sudden loud eruption of the audio signal among the electronic computing devices. Thus, the transition of the content is smooth and unnoticeable so the user 152 may even not be aware of the transition among the electronic computing devices, thus minimizing the content output interruption. In some examples, the content, particularly for video content, may be output at both the first and the second electronic computing devices 160a, 160b for an overlap of time when the user 152 is crossing a distance threshold between the first and the second rooms 102, 104. Thus, both first and the second electronic computing devices 160a, 160b may continue outputting until the first electronic computing device 160a no longer receives signals related to the user 152.

In another example, an algorithm configured in the content transition technique may also help the electronic computing devices to rank which of the surrounding or adjacent electronic computing devices in the environment are appropriate devices to output and receive the transferred content. For example, when playing audio content in the first electronic computing device 160a, such as listening to music, the first electronic computing device 160a may determine that a smart watch located nearby may not be an appropriate device to play the audio content. Thus, the audio content would not be requested to be transferred to such smart watch for output. Instead, the first electronic computing device 160a may search for other nearby appropriate devices for transfer, such as the second, third or fourth electronic computing devices 160b, 160c, 160d, that may be smart speaker devices.

Furthermore, in yet another example, the algorithm of the content transition technique may help smooth or modify a proximity metric programmed in each valid/active electronic computing devices 160. In this regard, when the electronic computing devices 160 are in use over time, a more stable and accurate confidence value and characteristics of the data/metric/parameters of each valid/active electronic computing devices 160 may be obtained. Thus, the transition and transfer of the content may be more accurate and reasonable. For example, a second closest electronic computing device relative to the user may receive a request to continue outputting the content with high confidence even if the user is moving toward and physically located closer to the first closest device. In other words, the second closest electronic device may continue playing the content with high confidence without transfer unless a fixed threshold of distance is reached to justify switch of the output to the first closest electronic computing device. Such fixed threshold of distance, relative locations of the electronic computing devices 160, layout, floor plan and room understanding of the environment may be pre-set in the proximity metric programmed in the algorithm of the content transition technique.

For example, when an electronic computing device, such as the second closest electronic computing device, outputting the content is estimated to be five feet away from the user, the content is not requested to be transferred to another electronic computing device, such as the first closest electronic computing device that is 4 feet 11 inches away from the user, as the distance is not large enough to trigger the transfer. In this case, the difference in distance is not large enough to trigger the device switching algorithm, which may include an information regarding a distance threshold. Such distance threshold may be set in the proximity metric. According to some examples, the distance/proximity threshold may be determined using machine learning. According to further examples, the distance/proximity threshold may be updated and modified by the algorithm of the content transition technique programmed in the electronic computing devices 160. This may assist in interpreting the proximity signal to predict an appropriate transfer to the nearby appropriate electronic computing devices.

In still another example, the algorithm of the content transition technique may also assist in calculating which electronic computing device is an appropriate electronic computing device to output the content at a given moment. For example, the algorithm may approximate the closest perceived electronic computing device, not in fact the quantitatively closest electronic computing device, to request performing the content at the closest perceived electronic computing device so as to avoid the content jumping back and forth between the electronic computing devices.

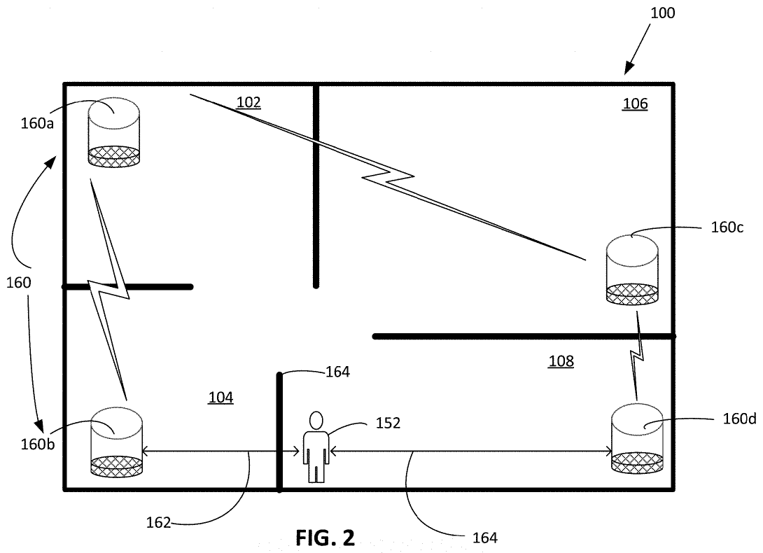

FIG. 2 depicts an example when the user 152 is located quantitatively close to the second electronic computing device 160b in the second room 106, but the content is more reasonable to be maintained outputting at the closest perceived electronic computing device, the fourth electronic computing device 160d, as the user 152 is physically located in the fourth room 108. In other words, even if the first distance 162 from the user 152 to the second electronic computing device 160b is shorter and closer than the second distance 164 from the user 152 to the fourth electronic computing device 160d, the algorithm, including the one using machine learning, may already be aware of the floor plan or layout of the building 100 among the rooms 102, 104, 106, 108 and predict that the user 152 is in fact physically located in the fourth room 108. As such, the algorithm may determine that a transfer is not necessary as the user 152 is located at the fourth room 108 and the closest perceived electronic computing device to the user 152 is the fourth electronic computing device 160d, which may enhance the delightfulness of the user experience. By doing so, the user 152 may move and walk around at the fourth room 108 while the content maintains outputting at the fourth electronic computing device 160d without random jumping back and forth to other electronic computing devices located nearby. In certain examples, a user's preference or habit, such as being allowed to play content in certain rooms other than in an office and the like, may also be programmed or machine learned to provide a high satisfactory user experience.

Thus, the awareness and understanding of the floor plan, layout or user habit/preference may assist determining a reasonable and appropriate content transfer among the electronic computing devices so that the user may move in the building 100 with seamless and reasonable content transfer that fits the user's expectation and preference.

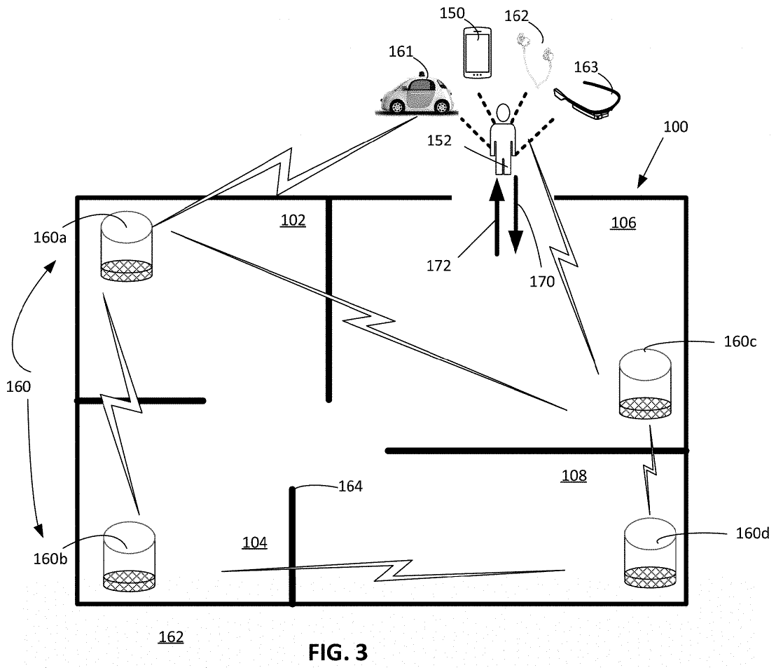

FIG. 3 depicts another example when the user 152 enters into the building 100 from an outdoor environment. When the user 152 is in close proximity to the building 100, one of the electronic computing devices 160 may detect and sense the presence of the user 152. The detection of the presence of the user 152 may be obtained by the electronic communications between the electronic computing device 160 and the holdable or wearable devices 150, 162, 163 carried by the user 150, or between the electronic computing device 160 or an automobile 161 with which the user 152 is engaged. For example, when the user 150 drives the automobile 161 approaching and getting in close proximity of the building 100, the electronic computing device 160 may be aware of the presence of the user 152 by the electronic signal transmitted from the automobile 161. As the automobile 161 becomes in a stationary state at a designated location of the building 100, such as a garage, the electronic computing device 160 may detect the content from the automobile 161 and request to transfer of the content from the automobile 161 to output at one of the electronic computing devices 160 to which the user 152 is approaching. In some examples, when the user 150 walks in the building 100 with earbuds 162, as indicated by the path 170, one of the electronic computing devices 160 may detect the presence of the user 152, for example by sensing the electronic signal transmitted from the earbuds 162, and request a transfer of the content from the earbuds 162 to output at one of the electronic computing devices 160 closest to the user 150 or most reasonable to the user 152. In some examples, the user 152 may enter the building 100 wearing a pair of smart glasses 163 or other suitable wearable devices. One of the electronic computing devices 160 may detect the presence of the user 152 and sense the electronic signal transmitted from the smart glasses 163 to request a transfer of the content from the smart glasses 163 to output at one of the electronic computing devices 160 closest to the user 150 or most reasonable to the user 152.

In some examples, similarly, when the user 152 exits the building 100, as indicated by the path 172, the content output at one of the electronic computing device 160 may then initiate a transfer to output the content at one of the wearable devices or holdable device 163, 162, 150 that the user 152 carries or to the automobile 161 as needed so that the user 152 may continue experiencing the content without interruption. In this regard, the system may wait to start the content transfer until the user is in the car to enhance the user experience of seamless transfer of content.

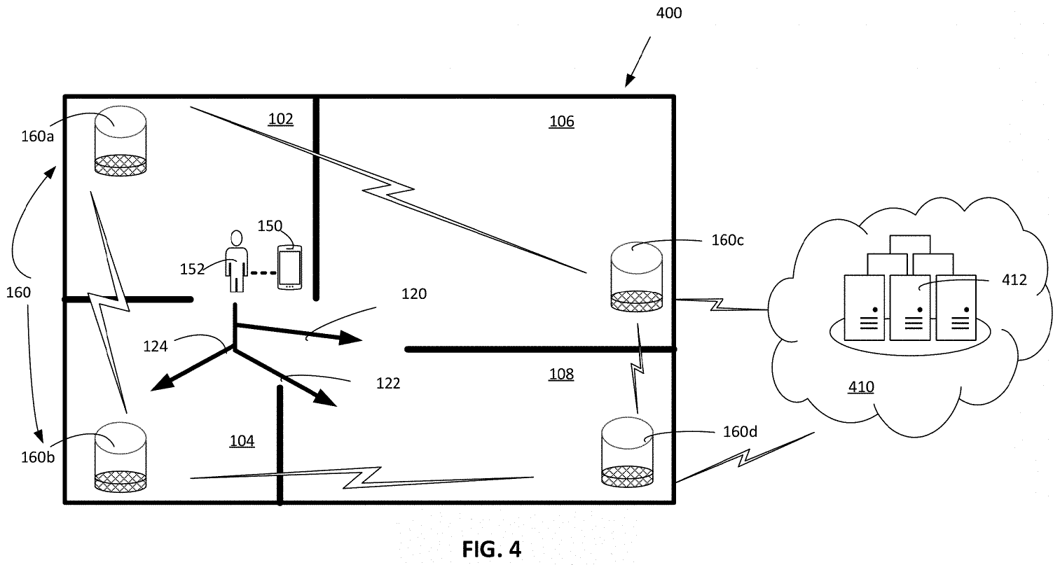

FIG. 4 illustrates another example of a building 400 with multiple electronic computing devices 160 located at multiple rooms 102, 104, 106, 108 respectively. In this example, the multiple electronic computing devices 160 may be in wireless communication with cloud services 410 via a network. In other examples, the electronic computing devices 160 may be in communication with the cloud services 410 through a wired communication system. The cloud services 410 refer to a network accessible platform implemented as a computing infrastructure of processors, storage, software, data access, and so forth that is maintained and accessible via the network, such as the internet, WiFi or suitable network systems. The cloud services 410 do not require end-user knowledge of the physical location and configuration of the system that delivers the services. Common expressions associated with cloud services include on-demand computing, software as a service (SaaS), platform computing, network accessible platform and so forth.

The cloud services 410 are implemented by one or more servers 412. Additionally, the servers 412 may host any number of cloud based services 410, such as one or more services to coordinate content transfer between the multiple electronic computing devices 160, perform database searches, locate and consume/stream entertainment (e.g., games, music, movies and/or other content, etc.), perform personal management tasks (e.g., calendaring events, taking notes, etc.), assist in online shopping, conduct financial transactions, understand and memorize user's habits and preferences, and so forth. In addition to the states of contents for a user, it could also manage states of devices as well as shared accounts for devices for multiple-user user cases of this disclosure. These servers 412 may be arranged in any number of ways, such as server farms, stacks, and the like that are commonly used in data centers.

In one implementation, the electronic computing devices 160 are configured to facilitate communication between the user 152 and the cloud services 410, for example, to perform various tasks and/or to stream various media content into the building 400. Accordingly, the user 152 may move between the first room 102 to the second room 104, for example, while continuing to consume/access/stream content and/or continue to perform one or more various tasks via the electronic computing devices 160.

In one example, the user 152 is watching a video streamed from cloud services 410 and output by the first electronic computing device 160a in the first room 102. As the user 152 moves from the first room 102 to the second room 104, as indicated by the path 124, the first electronic computing device 160a captures the user movement. The first electronic computing device 160a may provide the captured user movement to the cloud services 410. The cloud services 410 may determine the direction and movement of the user 152 by processing the capture movement and determine an appropriate electronic computing device 160 to transfer output of the video content. When multiple signals are both transmitted to the cloud services 410, such as the signals of the user movement both detected by the first and the second electronic computing devices 160a, 160b as the user 152 moves toward the second room 104, the cloud services 410 may compare the signal strength or time of flight (ToF) based signal technique related to the user 152 as captured by both the first and the second electronic computing devices 160a, 160b over time to determine the direction of movement.

After analysis of the captured signal, the cloud services 410 may then activate or awaken suitable electronic computing devices 160, such as the second electronic computing device 160b, to continue streaming the video at the second electronic computing device 160b. In one particular example, the cloud services 410 may stream the video to both the first and the second electronic computing devices 160a, 160b for a predetermined period of time before completing the transfer to the second electronic computing device 160b. By doing so, the user 152 may watch the video output from both the first and the second electronic computing devices 160a, 160b as the user 152 is crossing the distance threshold between the first and the second rooms 102, 104. In another example, the cloud services 410 may stream the video to both the first and the second electronic computing devices 160a, 160b until the cloud services 402 determine that the first electronic computing device 160a no longer receives signals related to the user 152. The cloud service may be used to improve machine learning algorithms used to predict user movement and best timing to transfer the content. It could be for a single user for personalized experience and/or be used as aggregated but not identifiable data to improve the algorithm as a whole for all users of this technology. The machine learning algorithm may be trained on-device, if, for example, if the user does not participate in the aggregated data collection.

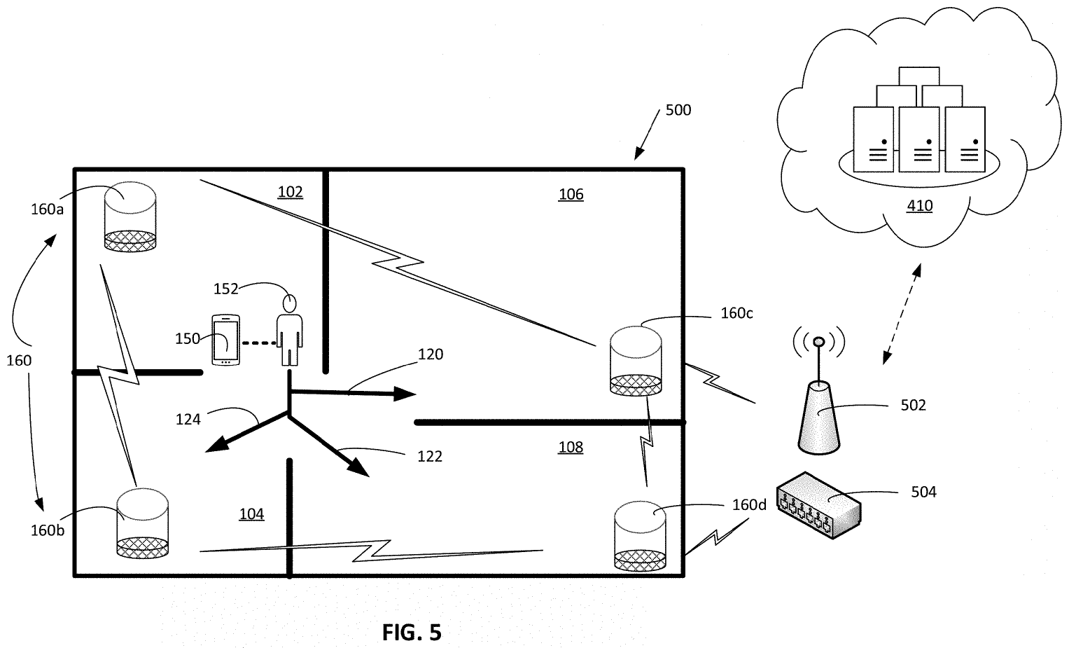

FIG. 5 illustrates an example environment including a building with multiple electronic computing devices 160 located in different rooms 102, 104, 106, 108 respectively. Similarly, instead of utilizing the cloud services 410 depicted in FIG. 4, a router 504 or wireless access point 502 in communication with each of the electronic computing devices 160a, 160b, 160c, 160d, as well as the cloud services 410 via network. In some cases, the router 504 or wireless access point 502 may facilitate communication among the electronic computing devices 160a, 160b, 160c, 160d, the holdable device 150 or other wearable device carried by the user 152, and the cloud services 410. For example, the wireless access point 502 may act as a master device in any appropriate computer network among the electronic computing devices 160a, 160b, 160c, 160d.

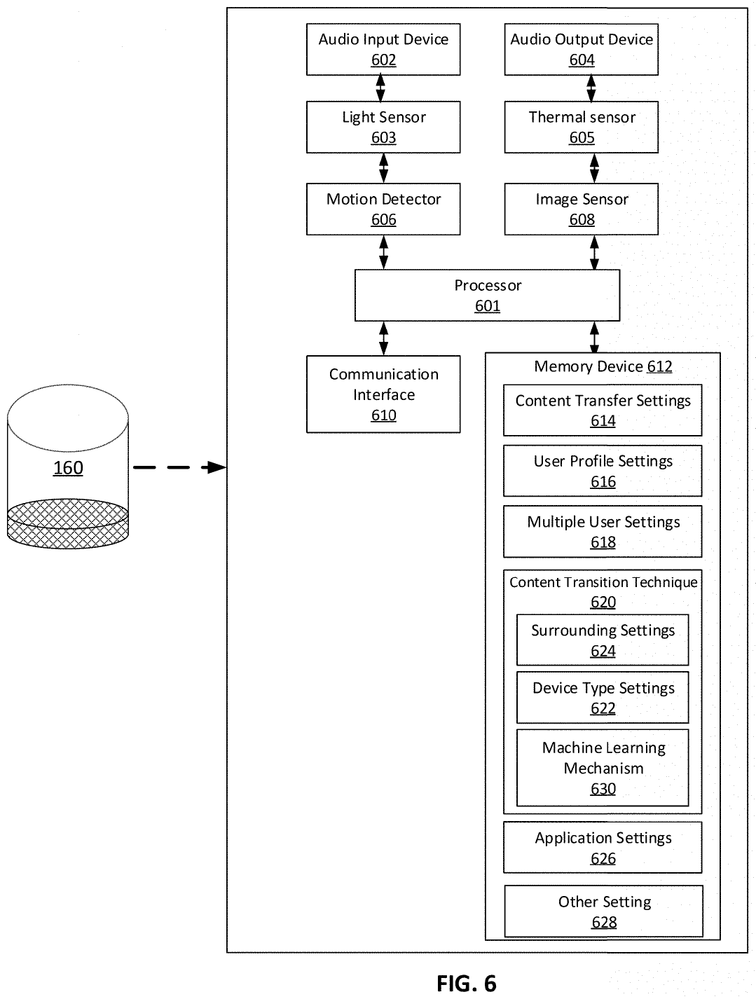

FIG. 6 depicts an example configuration of the electronic computing device 160. The electronic computing device 160 may be configured to perform multiple functions but have a relatively simple user interface, such as touch screens and alternatively in addition to voice user interactions, to provide an easy hands-on user experience. In one example, the electronic computing device 160 includes an audio input device 602, such as a microphone, and an audio output device 604, such as a speaker. The audio input device 602 may collect sound or voice from the adjacent environment and convert the sound into one or more audio signals. The audio output device 604 may regenerate audio signals as sound to broadcast at a preset volume to the environment. The audio input device 602 and the audio output device 604 enable two-way communication between the electronic computing device 160 and a user. The audio input device 602 provides voice recognition functions that may recognize particular users. The audio output device 604 may output responses based on users' profiles and individual settings.

The electronic computing device 160 can also include a light sensor 603, a thermal sensor 605, a motion sensor 606, and an image or camera sensor 608. When the ambient environment is dark, the light sensor 603 may detect darkness and activate the lights in the buildings 100. In some examples, the light sensor 603 may also detect the presence of a user. Since the specific user is known, the system is able to apply user preference such as brightness levels and colors. When a user is present in the room, the light sensor 603 may not only activate the light, but also provides a feedback signal to a processor 601 in the electronic device 160 for appropriate response, such as content transfer as needed.

The presence of the user may also be detected by the motion sensor 606 in the electronic computing device 160. The motion sensor 606 may detect movement in the environment to determine if a user is present and/or in motion in the environment. If a change in the location of the user relative to the environment/surrounding is detected, a feedback signal may be generated by the motion sensor 606 and transmitted to the processor 601 for analyzing and processing. Therefore, a decision may be made by the processor 601 to determine if a content transfer is necessary.

The thermal sensor 605 in the electronic computing device 160 may also assist detection of the presence of the user. The thermal sensor 605 may determine if a user is present in the environment by detecting a human body heat. Thus, the thermal sensor 605 may detect the presence of the user without the user in motion. Thus, the thermal sensor 605 may help identify the location of the user in the building so as to determine a proper response.

The image sensor 608 may provide one or more cameras and/or interfaces for receiving video and/or images or detecting user gestures in an environment in which the electronic computing device 160 is located, such as rooms 102, 104, 106 and 108 of FIG. 1. The image sensor 608 is configured to capture images of one or more users accessing or interacting with the electronic computing device 160, which may be used to authenticate the identity of the one or more users, for instance, by performing one or more facial recognition techniques to the image.

Any of these aforementioned sensors may be used in combination to increase confidence of detecting user presence, movement, and identity.

The electronic computing device 160 includes one or more communication interfaces 610 to facilitate communication among networks, multiple electronic computing devices 160, the router 504, the wireless access point 502, a master device and/or one or more other devices and/or one or more cloud services 410. The communication interface 610 includes at least one receiver and transmitter to communicate among the electronic computing devices 160 or the network system in the environment. The communication interface 610 may support both wired and wireless connection to various networks using centralized or variations of mesh network architectures, such as cellular networks, radio, WiFi networks, short-range or near-field network, Bluetooth, infrared signals, local area networks, wide area networks, the internet, and so forth.

The processor 601 in the electronic computing device 160 may be a control logic circuit, central processing unit, any suitable types of processors that may perform the functions in the electronic computing device 160 and analyze and process the signals generated from other devices or sensors 602, 604, 603, 605, 606, 608. A memory device 612, such as a computer readable media, may also be included in the electronic computing device 160. The memory device 612 may store different types of content as needed. Computer-executable instructions may be saved in the memory device 612 and executed by the processor 601 in the electronic computing device 160 when needed. It is noted that the software and algorithm in the memory device 612 may be updated and downloaded as needed.

In one example, the memory device 612 may be any type of device that may provide data storage. Suitable examples of the memory device 612 may include, but are not limited to, volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 601.

Several settings, such as instructions, content transfer criteria and rules, and user information/profile and so forth, may be stored in the memory device 612 and configured to execute on the processors 601. In one example, the memory device 612 may include content transfer settings 614, user profile information settings 616, multiple user settings 618, content transition technique 620, application settings 626 and other settings 628 as needed. It is noted that the data and/or software may also be live in the cloud service. In this regard, the computing devices are simply streaming devices.

As discussed above, certain threshold or user preference/habit and/proximity metric may be preset and predetermined prior to an initiation of a content transfer among different electronic computing devices 160. Thus, such content transfer settings 614 may be set, predetermined and stored in the memory device 612 so that the processor 601 may access such information and facilitate the transfer of content from one electronic computing device to another. Some of this data could also be tuned by the machine learning algorithm as necessary or manually updated by the user.

The user profile information 616 in the memory device 612 may provide user authentication information so as to verify the identity of a particular user before making select services/switches available via the electronic computing devices 160. The user profile information 616 may provide a list of authorized users and associated profile information, as well as content based on their preference or habits. The list of authorized users or priority users may include an authorization/priority list of users who have or who do not have permission to access the electronic computing devices 160. The user profile information 616 may also include authentication credentials, permissions, subscriptions, logon credentials (e.g., passwords and user names), contact lists (e.g., emails, phone numbers, etc.), settings, preferences, play lists, lists/indexes of electronic consumable content (e.g., favorite applications, most visited websites, media content preferences, etc.), histories (such as shopping or browsing histories), health history, and/or personal information associated with each of the authorized users. The content may be any content that is associated with the users.

In some examples, multiple user settings 618 may also be stored in the memory device 612. When more than one user is present in a room, a conflict of content output may occur. For example, when a first user is playing a first content in a first electronic computing device in a first room, a second user with a holdable device playing a second content enters the first room. The first electronic computing device may detect the second content, which is conflicting from the first content, when the second user walks in. In this regard, the processor 601 may perform conflict resolution between multiple users based on a priority list stored in the multiple user settings 618. The priority list may provide a user ranking information among multiple users, such as the host/guest relationship, parent/child relationship or the like, to determine who is the dominant user (e.g., the host or the parent) that has the authority to override or determine if a content transfer is appropriate. For example, continuing from the example above, the first electronic computing device may accept the transfer of the second content from the holdable device from the second user even though the first user is streaming the first content, as the holdable device from the second user may be ranked higher than first user on the priority list. In one example, a notification and/or an inquiry may be sent to the dominant user (e.g., the host or the parent) from the priority list to determine if the first electronic computing devices may accept a transfer to the second content from the holdable device prior to responding to the holdable device. The multiple user settings 618 may be in any user-friendly format to facilitate content transfer among multiple users.

In some examples, when the first user has overridden their setting to prohibit content transfer, such as similar to “Do Not Disturb” mode, then the system may disable the content transfer from the second user. In this regard, both or one of the first and second users may be notified of this setting. This setting remains effective even if the second user currently entering the room is set as the dominant user.

The “Do Not Disturb” mode can be determined from manual input from the users or automatically based on wearable device status, for example, when the user is asleep, busy for no disruption, or baby monitors. In this regard, the user may decide to control which of the devices 160 are currently available devices and may additionally use mechanisms, such as device groupings, to establish device control algorithm for each user.

Similarly, if there are multiple users in the room and one of the users, for example, the second user decides to leave the room, then the content may follow the second user while the content also continues to play in the room the first user is in.

As described above, the algorithm for the content transition technique 620 may also be stored in the memory device 612. The algorithm for the content transition technique 620 may also include the room understanding and/or floor plan recognition and/or proximity metric stored in the surrounding settings 624 so that a more reasonable and appropriate decision of content transfer may be made to the user. Furthermore, the algorithm for the content transition technique 620 configured to determine suitable output devices may also be stored under the device type settings 622. For example, as described above, a smart watch may not be a suitable device to output music or a video when being detected by the electronic computing devices 160. In other cases, if all other devices are not available, it may be used to transfer calls. Additionally, the machine learning mechanism 630 may also be programmed in the algorithm for the content transition technique 620. The machine learning mechanism 630, as described earlier above, may provide a good judgement for content transfer with relatively high confidence based on the multiple setting adjustments (e.g., from the user or from the ambient sensor feedback), data analysis for automatic analytical model building, preset proximity metric, massive input information accumulation and comparison, statistical calculation, or repetitive tests for data points analysis after use over time.

The application setting 626 may include some software applications, such as video playing platforms, movie streaming software, audio books or other suitable streaming applications, that may facilitate operation of the electronic computing device 160.

Some other settings 628, such as communication settings in a smart home environment or other ambient computing device settings, may also be stored in the memory device 612 to increase the intelligence and smartness of the electronic computing device 160 and enhance the level of the satisfaction of the user experience.

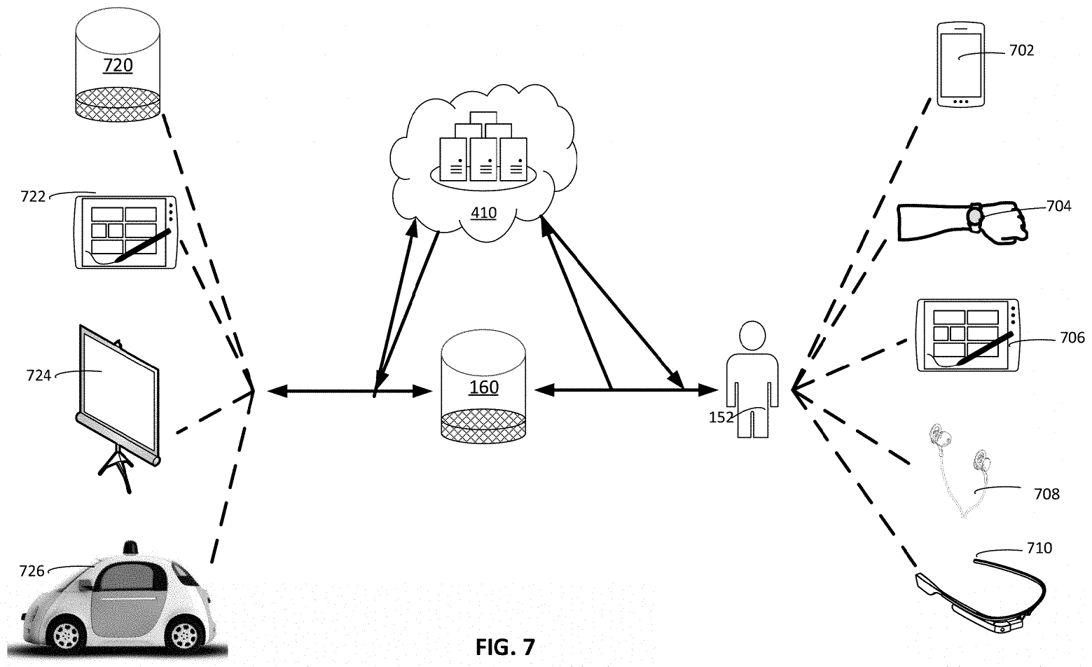

FIG. 7 depicts functional diagrams with regard to an interaction of a user to multiple electronic computing devices with multiple functions. For example, the user 152 may carry a portable device, holdable device or wearable device, such as a smart phone 702, a smart watch 704, a tablet 706, earbuds 708 or smart glasses 710, as the examples depicted in FIG. 7. The portable device, holdable device or wearable device 702, 704, 706, 708, 710 carried by the user 152 may provide an electrical signal when a content is actively output in these devices 702, 704, 706, 708, 710. When the user 152 is in close proximity to the electronic computing device 160, the electrical signal from the portable device, holdable device or wearable device 702, 704, 706, 708, 710 may be in electrical communication with the electronic computing device 160 so the electronic computing device 160 may determine and/or initiate a content transfer to output the content in the electronic computing device 160 with or without manually engaging in such transfer (e.g., a seamless transition). Alternatively, the electrical signal from the portable device, holdable device or wearable device 702, 704, 706, 708, 710 may be transmitted to the cloud service 410, or the router 504 or the wireless access point 502 as depicted in FIG. 5, and the cloud service 410 may then perform an electronic communication with the electronic computing device 160 to determine and/or initiate a content transfer. The electronic computing device 160 may further be in direct electrical communication or in indirect communication through cloud service 410, or the router 504 or the wireless access point 502 as depicted in FIG. 5, to other electronic computing devices, such as other electronic devices 720 similar to the electronic computing device 160, other tablets 722, a smart display 724, an automobile 726, or other suitable devices. For example, the electronic computing device 160 may determine if a content transfer is appropriate to transfer to other nearby electronic computing devices 720 as the user 152 moves. Some implementations of the seamless content transfer may not require a portable/holdable device, for example, if the network of input/output devices have sensors that can identify users on its own, such as cameras.

In one example, the electronic computing device 160 may determine if the content may be transferred to the smart display 724 when the content is a streaming video as the user moves. For example, as the user moves from a first room, such as a kitchen, to a second room, such as a living room, the electronic computing device 160 and/or the cloud service 410 may automatically switch the video or visual content from the tablet 722 located in the kitchen to the smart display 724 located in the living room. As the user leaves and exits the building, the content may then automatically switch and transfer to be output in other devices, such as the automobile 726, or the portable device, holdable device or wearable device 702, 704, 706, 708, 710 that the user carries. It is noted that the communications described herein are one-direction, bi-directional or multi-directional, which allows the portable device, holdable device or wearable device 702, 704, 706, 708, 710 to receive and send signals to and from the electronic computing devices 160 directly or indirectly through the cloud service 410. The electronic computing devices 160 may also receive and send signals to and from other electronic devices 720, other tablets 722, the smart display 724, or the automobile 726 directly or indirectly through the cloud service 410. In some examples, the portable device, holdable device or wearable device 702, 704, 706, 708, 710 may also be in communication with other electronic devices 720, other tablets 722, the smart display 724 or the automobile 726 directly or indirectly through the cloud service 410 or through the electronic computing devices 160.

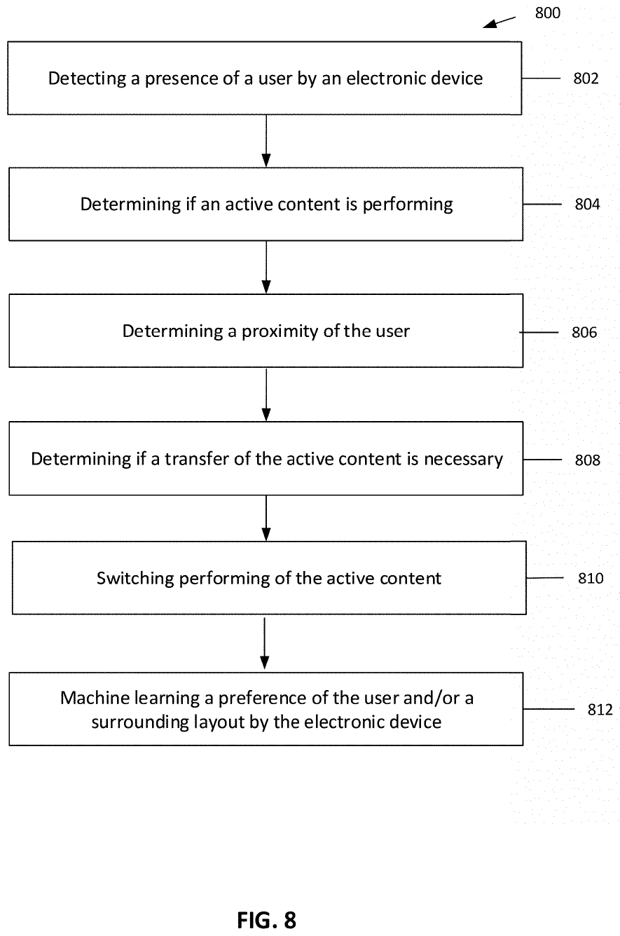

FIG. 8 depicts a flow diagram of a process 800 for providing a content transfer among electronic computing devices. The process 800 may be executed in the electronic computing device 160 depicted above with reference to FIGS. 1-7. The electronic computing device 160, in some examples, may be part of a system, such as an electronic computing system, with multiple and/or various types of electronic computing devices in communication with each other and/or one or more servers, such as the cloud service.

While FIG. 8 shows blocks in a particular order, the order may be varied and the multiple operations may be performed simultaneously or in any order as needed. Also, operations may be added or omitted.

The process 800 starts at block 802 by detecting a presence of a user. For example, the presence of the user may be detected by an electrical signal emitted from a portable device, holdable device or wearable device carried by the user. Alternatively, the presence of the user may be detected by an audio/sound command from the user detected by the audio input/output devices 602, 604 in the electronic computing device 160. The presence of the user may also be detected by an image or motion captured by the motion sensor 606, 608 in the electronic computing device 160. The presence of the user may also be detected by the temperature variation from the ambient environment detected by the thermal sensor 605 in the electronic computing device 160 or by activation of the light sensor 603. It is noted that the proximity and the presence of a user may be detected by any suitable techniques to improve the detection accuracy.

At block 804, the electronic computing device may determine if a content is actively output from the portable device, holdable device or wearable device carried by the user, or any other electronic computing devices located nearby. For example, the electronic computing device may send an inquiry to other electronic computing devices, including the portable device, holdable device or wearable device carried by the user, to determine if a content is actively output in any types of the electronic computing devices associated or related to the user. If the content is not currently being played on any of the devices, then the portable device or devices 160 may provide a user interface (via voice or screen) to display/play content on the appropriate device (i.e. closest device), which is automatically derived from 802.

At block 806, based on the detected strength of the electronic signal, time of flight (ToF) based signal, or any other methodologies from block 804, a proximity of the user relative to the available electronic computing devices in the environment is obtained. A proximity metric stored in the electronic computing device, such as configured in the smooth technique programmed in the memory device of the electronic computing device, may then be utilized to determine if a distance threshold is reached as the user moves.

At block 808, a decision may be made by the electronic computing device to determine if a transfer of the active content is appropriate. For example, as the user moves from room to room and the user is sufficiently close to another device based on a preset distance threshold over a certain period of time, the electronic computing device may determine an appropriate content transfer from the electronic computing device outputting the content to another electronic computing device that the users is in close proximity to.

At block 810, when a decision is made to make such a transfer, the electronic computing device outputting the content may request another electronic computing device to relay and output the content continuously at the other electronic computing device.

At block 812, as the electronic computing devices are in use over time by the user, the user's preference, privacy setting, habit, ambient understanding, floor plan/room learning, proximity metric and other associated information about the environment/surroundings and the user information may be stored, updated, modified and configured in the electronic computing devices. Thus, the electronic computing devices may learn from data, signals, privacy setting and patterns as detected to make proper decisions automatically and statistically with minimum intervention from the users. This could be used to improve the personalized experience as well as the overall algorithm shared across all users.

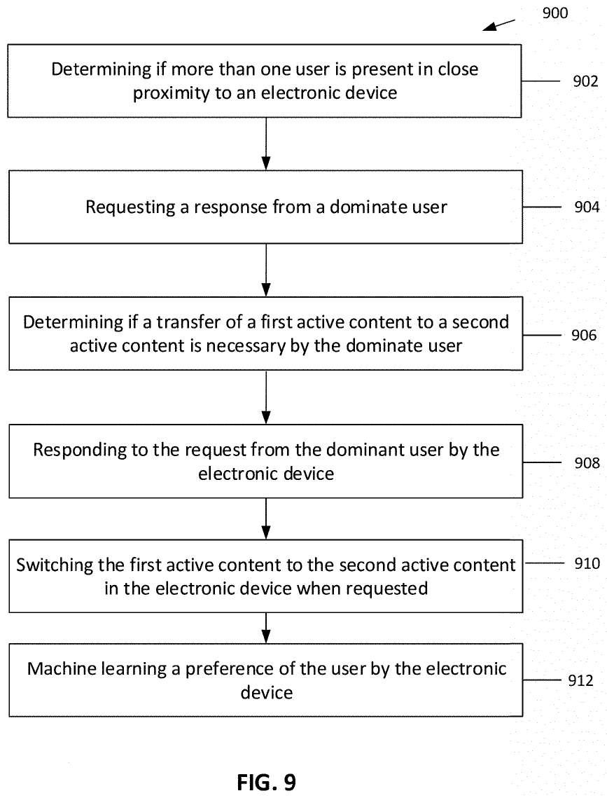

FIG. 9 depicts an example flow diagram of a process 900 when multiple users are present in close proximity. The process 900 may be executed in the electronic computing device 160 depicted above with reference to FIGS. 1-7. The electronic computing device 160, in some examples, may be part of a system, such as an electronic computing system, with multiple and/or various types of electronic computing devices in communication with each other and/or one or more servers, such as the cloud service.

Similarly, while FIG. 9 shows blocks in a particular order, the order may be varied and the multiple operations may be performed simultaneously or in any order as needed. Also, operations may be added or omitted.

The process 900 starts at block 902 by detecting if multiple users are present in close proximity, such as in a room. As discussed above, the presence of the users may be detected by an electrical signal emitted from a portable device, holdable device or wearable device carried by the users, or other manners as described above. For example, multiple users in close proximity may occur when a first user is in a room having a first content actively output in an electronic computing device located in the room and a second user then promptly enters the room. Alternatively, multiple users may enter the room at a similar time point but one or more of the users have different active content output at their individual portable device, holdable device or wearable device. Alternatively, there may be multiple users in the same room.

At block 904, when detecting the multiple users are in close proximity in the room, the electronic computing device in the room may detect if the second user has a second content in active or multiple users have conflicting contents in active. If so, a request and/or a notification may be sent from the electronic computing device to notify one of the users to determine if a switch of the content output is necessary. In one example, such user may be a dominant user preset in the priority list. For example, when such a dominant user is the first user already in the room outputting the first content in the electronic computing device, the first user may receive a notification from the electronic computing device, understanding that the second user becomes in close proximity with the second content in active. In contrast, when such a dominant user is the second user who is entering the room, the second user may receive a notification from the electronic computing device, understanding that the first user is already outputting the first content in the electronic computing device in the room. In some examples, the notification may interpret implicit confirmation, such as according to the setting on the priority list, if no user action is taken. In other examples, the non-dominant user may receive the notification and may need to initiate conflict resolution manually or automatically.

As described above, the priority list preset or saved in the algorithm, such as a switching algorithm, of the electronic computing device may determine which user is the dominant user who can control an appropriate content transfer among different electronic devices in the environment. It is noted that the switching algorithm may also be configured as an instant input-to mechanism that allows the user to instantly control content transfer and resolve the conflict by responding to the notification when happens. In the example wherein the multiple users enter the room about the same time point, the priority list preset or saved in the electronic computing device may determine a dominant user among the multiple users. The electronic computing device may then send a notification/inquiry to request instruction from the dominant user to determine which content from which user may be output in the electronic computing device.

At block 906, the dominant user may determine the content transfer is necessary or appropriate or not. For example, the dominant user may determine and send a feedback response to the electronic computing device. In one example, the dominant user may accept a content transfer to output a different content from another user. In another example, the dominant user may refuse transfer of the content as needed.

At block 908, after receiving the feedback response from the dominant user, the electronic computing device may respond to the feedback response and output the appropriate content.

At block 910, in the example wherein the dominant user is determined to transfer the content, the electronic computing device may then output a different content provided from the other user. In the situation that the dominant user decides no transfer is necessary, the operation at block 910 may be eliminated or omitted. In some examples, when the dominant user leaves the room, the content may be determined to be left and continued outputting in the electronic computing device in the room, or to follow the dominant user to other locations. Alternatively, when the dominant user leaves the room, the content may stop to play, allowing the electronic computing device becomes free for the remaining user to play their content. Although other similar examples may not be illustrated here, the switching algorithm may include different scenarios here as needed to facilitate the user experience.

At block 912, as the electronic computing devices are in use over time by the users, relationships and priority among different users may be automatically stored, updated and configured in the electronic computing devices. Thus, the electronic computing devices may learn from data, history, signals, and patterns as detected to make proper decisions automatically with minimum intervention from the users.

Thus, methods, architects and algorithms to improve smoothness, efficient and seamless content transfer among multiple electronic computing devices are provided. In one example, the content transfer may be achieved by detecting a movement of a user by one electronic computing device and responding to the user movement by requesting a content transfer or relay of the content to another electronic computing device with or without the user knowing (e.g., with or without requiring user to manually initiate) such transfer. The smooth and seamless content transfer may be achieved by detecting a proximity of a user relative to multiple electronic devices and potentially additionally using a machine learning algorithm in the electronic computing device to justify a proper and appropriate content transfer that is most reasonable to the user. Thus, the content may be automatically transferred and coordinated across the electronic computing devices by detection of a proximity and/or a movement of the user. A user triggered transfer, such as a voice command, audible request, or other types of user activation, may be eliminated so that a smooth and seamless transfer of the active content across different electronic computing devices may be obtained with minimum activation/action required from the user.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. An electronic computing device comprising:
one or more sensors adapted to detect proximity of a user to the electronic computing device;
a communication interface;
a memory device configured to store computer-executable instructions; and
a processor in communication with the memory and one or more sensors, wherein the processor is configured to:
determine, based on information from the one or more sensors, a proximity of a user relative to the electronic computing device; and
determine, based on a proximity metric, whether to transfer output of content to or from a second electronic computing device.

2. The electronic computing device of claim 1, wherein the communication interface comprises at least one receiver and transmitter to communicate with the second electronic computing device.

3. The electronic computing device of claim 1, wherein the one or more sensors comprises at least one of an audio input device, audio output device, light sensor, motion detector, thermal sensor, or image sensor.

4. The electronic computing device of claim 1, wherein the proximity of the user is detected by strength of an electronic signal from a portable device, a holdable device or a wearable device carried by the user.

5. The electronic computing device of claim 4, wherein the electronic signal is at least one of WiFi signal, Bluetooth signal, ultrasonic signal, time of flight (ToF) based signal or a cloud service signal.

6. The electronic computing device of claim 1, wherein the memory device provides an algorithm configured to execute the proximity metric to determine the transfer of the content.

7. The electronic computing device of claim 6, wherein the algorithm is automatically updated by machine learning.

8. The electronic computing device of claim 6, wherein the algorithm provides a gradual fading of the content when the content is determined to be transferred.

9. The electronic computing device of claim 6, wherein the algorithm provides a priority list to determine the transfer of the content when multiple users are present in the environment.

10. The electronic computing device of claim 1, wherein the proximity metric comprises floor plan or room understanding.

11. An electronic computing system, comprising:
a first electronic computing device located in a first location in an environment; and
a second electronic computing device located in a second location of the environment, wherein the first electronic computing device comprises:
one ore more sensors;
a communication interface;
a memory device configured to store computer-executable instructions; and
a processor, wherein the processor is configured to:
determine a proximity of a user relative to the first electronic computing device in the environment detected by the one or more sensors; and
determine a transfer of content to the second electronic computing device based on a proximity metric stored from the memory device.

12. The electronic computing system of claim 11, wherein the content is output in the second electronic computing device in response to determining to transfer the content.

13. The electronic computing system of claim 11, wherein the communication interface facilitates electrical communication between the first and the second electronic computing device.

14. The electronic computing system of claim 13, wherein the electrical communication is by at least one of WiFi, Bluetooth, ultrasonic, time of flight (ToF) based signal, or cloud service.

15. The electronic computing system of claim 11, wherein the proximity metric comprises floor plan or room understanding.

16. The electronic computing system of claim 13, wherein the content is automatically transferred to the second computing device through the electrical communication therebetween.

17. The electronic computing system of claim 13, wherein the memory device provides a content transition technique executed by the one or more processors to provide a smooth transition of the content.

18. The electronic computing device of claim 17, wherein the determining, based on the proximity metric, is updated by machine learning.

19. A method for content transfer, comprising:
detecting, with one or more sensors, a presence of a user by a first electronic computing device;
determining, with one or more processors, a proximity of the user relative to the first electronic computing device in an environment; and
determining, with one or more processors, whether to transfer content from the first electronic computing device to or from a second electronic computing device based on a proximity metric in the first electronic computing device.

20. The method of claim 19, wherein the proximity metric comprises floor plan or room understanding.
